(19) United States
(12) Patent Application Publication
(10) Pub. No.: US 2010/0238033 A1
(43) Pub. Date: Sep. 23, 2010

(54) Tracking and Alert Apparatus, System and Method

(76) Inventors: Dan Blumel, Newhall, CA (US); Kari Joseph Sikias, Los Angeles, CA (US)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(21) Appl. No.: 12/728,339

(22) Filed: Mar. 22, 2010

Related U.S. Application Data
(60) Provisional application No. 61/162,217, filed on Mar. 20, 2009.

(51) Int. Cl. G08B 23/00; G08B 5/22

(52) U.S. Cl. 340/573.4; 340/825.49

(57) ABSTRACT

The present invention is directed to a tracking device, system and method that may utilize GPS, global system for mobile communications (GSM) or general packet radio service (GPRS), including using triangulation, and/or wireless local area network (WLAN) technologies to improve the scope, range, reliability, convenience and speed of current tracking devices. The present invention may employ a wearable or attachable device to track persons, such as children or the elderly, or objects, for example. The wearable device may be designed to be secured to the wearer to track the wearer's whereabouts. Unauthorized removal, destruction, or tampering of the tracking device may result in alerts being sent out to a variety of monitoring stations. The tracking and alerts, for example, may be monitored via a convenient remote monitoring interface.

### CROSS-REFERENCE TO RELATED APPLICATIONS

The present application claims the benefit of priority to U.S. Provisional Application Ser. No. 61/162,217, entitled “Personal Tracking and Alert System” and filed Mar. 20, 2009 with inventors Dan Blumel and Kari Joseph Sikias, which application is incorporated by reference herein as if set forth in the entirety.

### BACKGROUND OF THE INVENTION

1. Field of the Invention

The invention relates to wireless tracking devices, and, more particularly, to a tracking and alert apparatus, system and method.

2. Description of the Background

Global position system (GPS) has revolutionized the ability to track individuals with relative accuracy. Commercialization of GPS has not only improved the driving experience, but is now at the forefront of individual safety and security. As commercialization avenues for GPS have increased, the cost of GPS-based devices has decreased. GPS devices are now incorporated into small handheld devices that may be carried by individuals, to thereby allow for locating of the handheld device. Utilizing this technological advancement, the location of the handheld device may be used to monitor the location of persons or objects.

GPS technology, however, has its limitations. Most notably, if the signals from the GPS satellites are blocked, such as when the receiver is indoors, it becomes ineffective. In addition, the time to locate at signal may take tens of seconds, which may seem very long under duress. Further, a handheld or similar small device is not useful to track the carrier of the device if the device may simply be removed by the carrier. Thus, it would be advantageous to make the device more attractive and/or enjoyable for the carrier to maintain on his or her person. Moreover, the capability to track the location of the device is relatively inconveniently provided in the available art.

Additionally, technologies such as GPS are not presently effectively used for tracking of persons. For example, 800,000 children are reported missing each year in the United States alone. Nevertheless, due to the difficulty of convincing children to wear and/or otherwise keep tracking devices with them, the inconvenience and bulkiness of typical tracking devices, the inappropriateness of providing younger children with cellular devices, and the typical expense of tracking devices, child safety from abduction is relatively unaddressed by the use of GPS tracking devices.

Thus, the need exists for a personal tracking device, system and method that improves the tracking scope, range, reliability, convenience and speed of available devices.

### BRIEF SUMMARY OF INVENTION

The present invention is directed to a tracking device, system and method that may utilize GPS, global system for mobile communications (GSM) or general packet radio service (GPRS), including using triangulation, and/or wireless local area network (WLAN) technologies, to improve the scope, range, reliability, convenience and speed of current tracking devices. The present invention may employ a wearable or attachable device to track persons, such as children or the elderly, or objects, for example.

The tracking device, system and method of the present invention may be employed in an everyday wearable accessory, such as a wristband. The wristband may be designed to be secured to the wearer to track the wearer's whereabouts. Unauthorized removal, destruction, or tampering of the tracking device may result in alerts being sent out to a variety of monitoring stations. The tracking and alerts, for example, may be monitored via a convenient remote monitoring interface, for example.

Therefore, the present invention provides a personal tracking device, system and method that improves the tracking scope, range, reliability, convenience and speed of available devices.

### BRIEF DESCRIPTION OF THE DRAWINGS

Understanding of the disclosure will be facilitated by consideration of the following detailed description of the embodiments, taken in conjunction with the accompanying drawings, in which like numerals refer to like parts and in which:

FIG. 1 is a perspective view of an embodiment of the present invention;

FIG. 2 is a cross-section of FIG. 1;

FIG. 3 is a flow diagram of the present invention;

FIG. 4 is a block diagram illustrating a tracking system;

FIG. 5 is an illustration of a tracking monitoring device; and

FIG. 6 is an illustration of block diagram of a circuit according to an aspect of the present invention.

### DETAILED DESCRIPTION OF THE INVENTION

It is to be understood that the figures and descriptions have been simplified to illustrate elements that are relevant for a clear understanding, while eliminating, for the purpose of brevity, many other elements found in typical communication and tracking devices, systems and methodologies. Those of ordinary skill in the art will thus recognize that other elements and/or steps are desirable and/or required in implementing the present invention. However, because such elements and steps are well known in the art, a discussion of such elements and steps is not provided herein. The disclosure herein is directed to all such variations and modifications of such elements and methods known to those skilled in the art. Furthermore, the embodiments identified and illustrated herein are for exemplary purposes only, and are not meant to be exclusive or limited in their description.

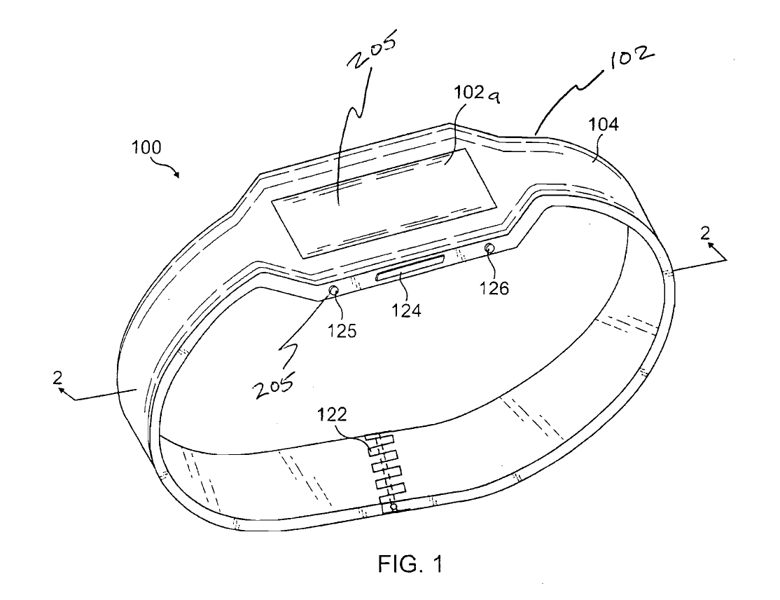

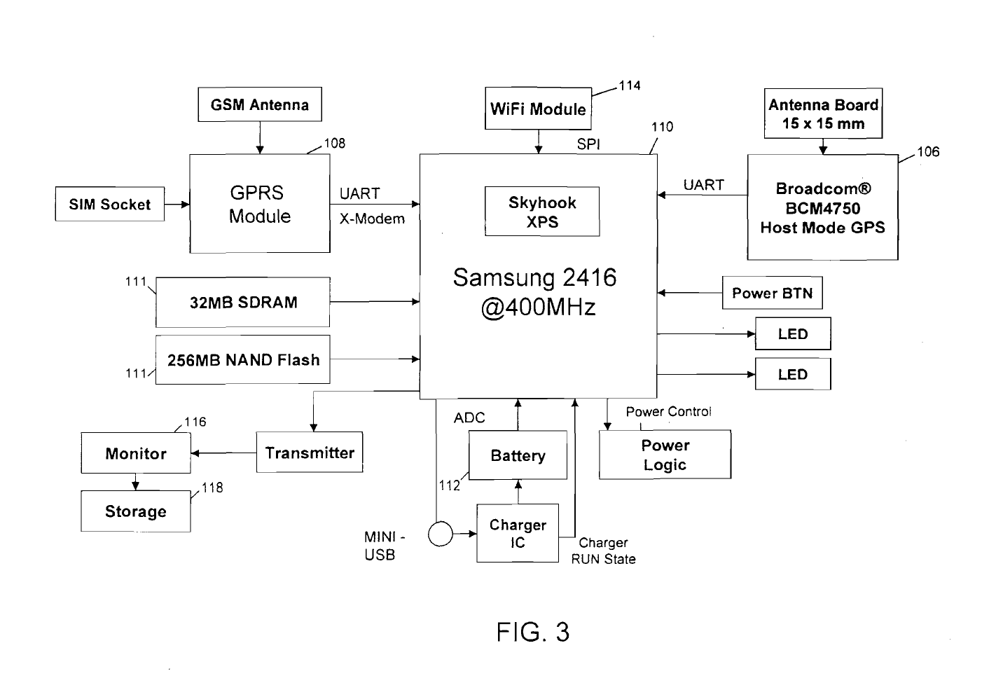

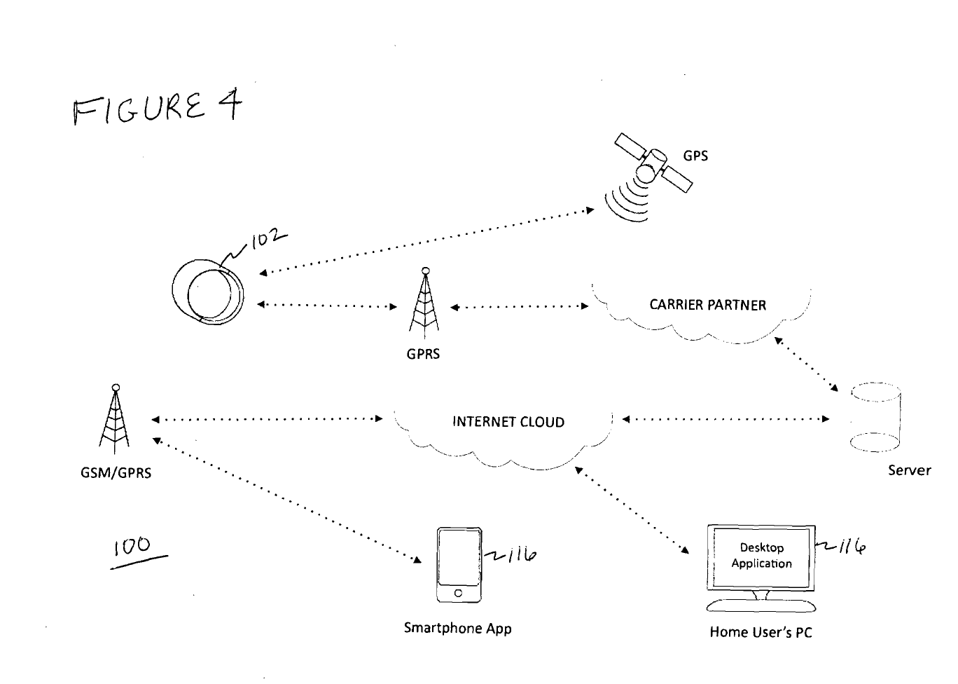

With reference to FIGS. 1, 2, 3 and 4, the present invention is directed to an improved tracking and alert system 100 that provides a greater tracking range by utilizing global positioning system (GPS) technology, global system for mobile communications (GSM) or general packet radio service (GPRS), and/or related cell phone technology, wireless local area network (WLAN) technology, such as WI-FI®, or any combination thereof, to locate individuals and/or property quickly and easily with a broader scope, range, and speed than is presently available. Although various embodiments discussed hereinthroughout are detailed with respect to parents and children, those skilled in the art will appreciate that the present invention is similarly applicable to monitoring or tracking of the elderly, the ill, and objects, for example.

The tracking and alert system 100 may include a tracking module/device 102 with fastener 104, that improves the range of locating, minimizes tampering, reduces the delay of responding to trouble, and is durable yet fashionable. The tracking system 100 may further include a monitor 116 to track the location of the tracking module 102 from a remote location.

To improve the range of locating an individual, the tracking module 102 may utilize, and include the necessary equipment, microprocessors and the like for, GPS, GPRS, WLAN technology, or any combination thereof. Current tracking devices utilizing only GPS technology are limited when satellite signals are blocked, such as when the GPS receiver is indoors, under a tunnel, between tall buildings, and the like. By complementing the GPS technology with GPRS, GSM, cellular, triangulation, and/or WLAN technology, the range of tracking may be vastly improved.

The tracking module 102 may include a GPS module 106 and GPRS or other module 108, connected to a processor 110, such as via a universal asynchronous receiver-transmitter, to receive position information of the tracking module 102 and transmit the position information to the monitor 116. The processor 110 executes instructions to process the data received from the various modules to calculate the position information, and transfers that information to the monitor 116. The processor 110 receives power from a power source 112, such as a battery. In some embodiments, a WLAN, broadband, or the like module 114, such as WI-FI®, is also connected to the processor 110, such as to download applications 205 as discussed immediately hereinbelow.

Tracking module 102, may include one or more applications 205, such as entertainment applications, such as games or the like. These applications 205 may be embodied in software, in hardware, such as lights, such as LEDs, or in a combination of hardware and software. These applications may be self contained within module 102, or may remotely interact with, for example, the monitor 106, such as via module 114 included in and to effectuate the applications, module 102 may be equipped with the necessary hardware 205, such as the aforementioned lights, one or more buttons, one or more speakers, one or more microphones, a screen, such as a monochromatic or multichromatic screen, one or more accelerometers, or the like, for example. Software aspects of the applications 205 may be available online, such as via an online and/or application store, such as from a website or server associated with a provider of the tracking system 100 of the present invention. The software applications 205 may be downloadable via plug-in to a computing system, for example, or via cellular, broadband, or the like capabilities 114, which may be embedded, for example, in tracking device 102. The applications 205 may be include aspects provided by, for example, third party developers, and thereby the device 102, and driver software associated therewith, may include an open application interface, for example.

Needless to say, the device 102 may include one or more accessories. Accessories may include, for example, skins for device, wherein such skins may clip on to device, such as mechanically or magnetically clipping. Likewise, accessories may include peripherals, such as plug-in memory, an audio recording or play device, a joystick or similar gaming element, a video device, or the like. For example, the device 102 may further include a removable, decorative cover 128 to present an aesthetically pleasing device 102, disguise the tracking and alert system 100, or warn predators of the presence of a tracking and alert system 100. The covers 128 may be designed to be easily removable so as to be exchangeable with other decorative covers 128. The decorative covers 128 may also be constructed of material that may serve as a shock absorber to facilitate the durability of the device 102. For example, the cover 128 may be made of rubber or foam. In some embodiments, the fastener 104 of the tracking and alert device may be water resistant and/or include a fire-retardant or fire-resistant material.

The GPS and/or other locating module 106 may utilizes the satellites and the principles of trilateration, triangulation, or similar principles to locate the tracking device 102. The position information may be returned to the tracking device then transmitted to the monitor 116. Alternatively, the position information may be transmitted directly to the monitor 116. For example, GPRS, GSM, and assisted-GPS utilize cellular phone technology to locate the position of the tracking device 102. Using signal strength and movement relative to the known location of a nearby tower, the processor may calculate the precise location of the tracking device, and send the location to the monitor 116. Location information calculated by other methodologies by module 106 may be compared with the GPS information, such as when GPS information becomes available after suffering a blocked signal, for example. Foe example, using the media access control address (MAC address) and the known location of access points, WLAN may be used to further locate the position of the tracking device 102, such as by using a third party service, such as a service provided by Skyhook Wireless®. Skyhook Wireless® is capable of providing accurate position location up to 20 meters with 99.5% availability, and a time-to-first-fix within one second. The position information received from these technologies may be integrated by module 106, and then transmitted to the monitor 116.

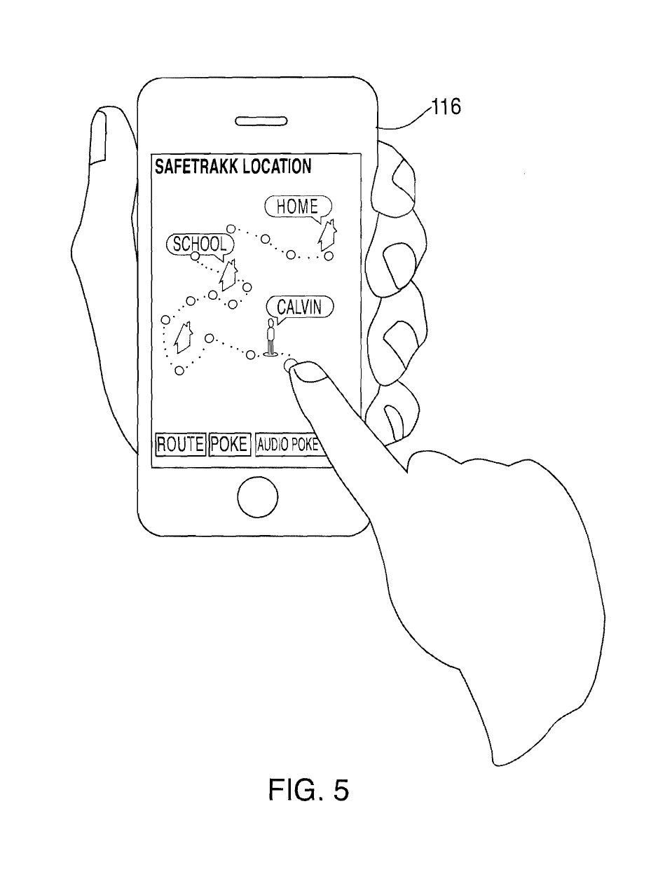

The monitor 116 may be a personal computer, a service provider, a mobile phone, a personal digital assistant, or any other electronic device that may receive wireless information or information through the internet. An exemplary monitor 116 is illustrated with respect to FIG. 5. The tracking and alert device 100 may transmit a signal to a single monitor 116, a plurality of monitors 116, or a monitoring station 116. The signal may be an alert, such as an audible or visual alert. In addition, the signal may be the coordinates of the tracking device. Further, the transmitted signal may be, for example, one or two way communication between the monitor 116 and the tracking device 102.

Such communication may be the aforementioned safety alert, audible and/or voice communications that may be initiated by only one, or both, parties, visual communications, and/or a remote gaming interaction, for example. For example, a visual communication may be in real time, or may be a pre-elected and/or triggered action. By way of example, a visual communication may be provided in the form of a light on the device 102, and/or a correspondent light on the monitor device 116. The meaning of such visual communication may be predefined by the device 102, and/or may be defined by the parties' communications, e.g. a parent informs a child that, when she lights a green light on a child device 102 activated remotely using monitor device 116, it means “I miss you.” Similarly, audio communications may be in real time, or may be recorded and played on one of the monitor device 116 and the tracking device 102 responsive to time expiration or a trigger, for example.

The monitor 116 may be associated with its own processor to convert the coordinates into a visual map of the location of the tracking device 102. For example, software may integrate the coordinates into pre-existing maps, such as those provided by, Google™, MapQuest®, Yahoo!, maps.com, and the like. Alternatively, programs may be provided to create and design original maps, including interactive maps. The system 100 may be purchased, for example, based solely on the basis of the tracking/mapping service to be provided on monitor 116 to track device 102, such as by a monthly service, and/or may be purchased on a per application basis, and/or aspects may be purchased with the purchase of any one or more hardware portions discussed herein.

Likewise, the mapping or monitoring may be enabled to operate on the monitor device 116 in multiple modes. For example, a photo, avatar, animation, or the like of a child may be provided on a display screen communicative with a web-enabled device 116, such as a computer or a digital picture device, in association with a geographic map, a safety zone map, or the like, in a passive mode. Such a display may be provided, for example, as a thick client or thin client application. A parent may thereby, for example, send a child an alert or warning, such as by “buzzing” the child using a buzzer embedded in device 102, when the child leaves an authorized safety zone as shown on the display at monitor 116. Additionally, in an active mode, a user of monitor device 116 may request that a child be found correspondent to device 102, set up a safety zone and sound an alarm when the zone is left, set up an alert when a speed is exceeded or an impact occurs, e.g. when the tracking device 102 is moving greater than a known speed limit, such as based on the aforementioned accelerometer in device 102, or receive or request an emergency alert, such as when a child presses a single button to alert of an emergent situation.

All data feed and information may be stored on a storage medium 118 at the monitor 116. This allows the travel history to be readily accessible even if the tracking device 100 is not. Tracking of history may allow, for example, for modification and/or expansion of safety zones. More specifically, if a male child is authorized to be in a safety zone outside his school, that includes playing soccer on a soccer field, but is shown to have left that safety zone on 6 days out of 8 to play on an adjacent basketball court, that history may indicate to the parent that the safety zone should be expanded to include the basketball court. Of course, limited storage may also be available embedded in device 102.

In some embodiments, the monitoring station 116 may be a publicly displayed electronic billboard or sign, such as those displaying AMBER Alerts™. When receiving an alert, the electronic sign may display a signal to indicate the location of the tracking device 102, or to indicate that the tracking device 102 is approaching the electronic sign. The electronic sign may display a map or a simple visual cue, such as a blinking red light or the like. The light may blink faster as the tracking device approaches the electronic sign. This will help recruit the public in reporting abductions and the like. Audible signals may be used similarly.

To reduce tampering with the tracking module 102, the tracking module may be connected to, and/or be part of, a fastener 104, which may in turn secure the tracking module 102 to the wearer. The fastener 104 may be any article that may secure the tracking module 102 to the wearer's body. For example, the fastener 104 may be a wristband or bracelet, a ring, a necklace, a belt, a vest, and the like. Preferably, the fastener 104 should not be easily removable from the wearer so as to reduce or prevent unwanted or unauthorized removal. Preferably, the fastener is a wristband.

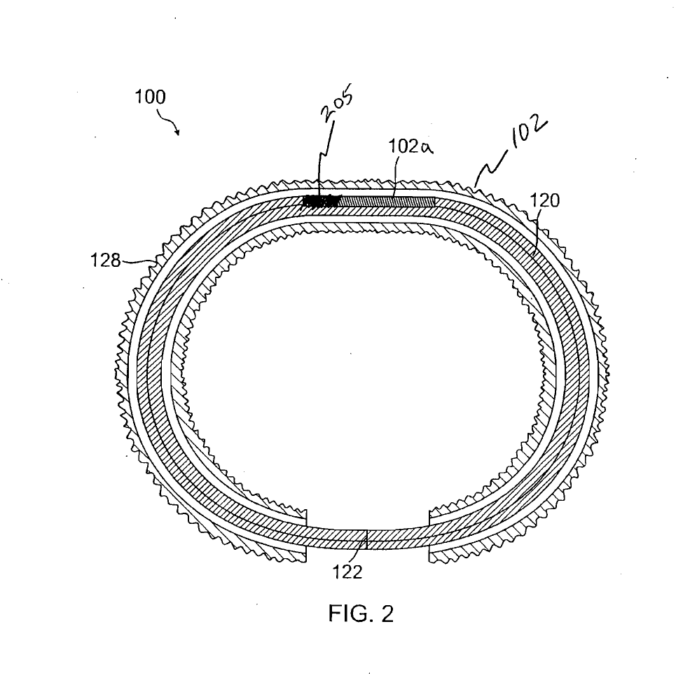

As shown specifically in FIG. 2, the fastener 104 may provide a means for detecting when the fastener 104 and/or the tracking module 102 have been compromised or otherwise unwillingly removed. For example, the fastener 104 may be embedded with an electronic circuit 120, wherein the circuit 120 is completed through the connection to the tracking module 102 and the fastener 104. Thereby, disruption of the integrity of the fastener 104, either through destruction or disconnection of either the fastener 104 or the tracking module 102, may interrupt the electronic circuit 120, which may thus alert the monitor 116.

The fastener 104 may further include a locking mechanism 122 to secure the tracking and alert system 100 to the wearer. The locking mechanism 122 may be a type of lock and key, a combination lock, a switch, or any other type of lock requiring a specific removal protocol or key device. The locking mechanism 122 is configured to fit on the fastener 104 without frustrating the comfort of wearing the tracking and alert device 102. To unlock the tracking and alert device 100, the locking mechanism 122 may require a key device, a password, a code, a specific identification, or a precise sequence of actions, for example.

To further reduce unwanted removal of the fastener from the wearer, the fastener may be constructed from strong durable material, such as a metal or metal composite, polymer, textile, other types of material, or any combination thereof. The fastener 104 should be durable and lightweight. In a preferred embodiment, the fastener 104 may include a high strength polyethylene fiber, such as that manufactured under the trademark DYNEEMA®.

In some embodiments, the mere loss of the position signal at the tracking device 102 may trigger an alert. Since loss of signal at the tracking device 102 may also send an alarm to the monitor 116, utilizing the combination of GPS, GPRS, GSM and WLAN technologies may reduce the potential for false alarms. For instance, when indoors, the GPS signal may be lost, but since the GPRS and/or the WLAN signal would still be present, an alarm would not be sent to the monitor 116. Thus, the processor 110 may perform a check to determine whether a signal is being received from at least one of the receivers. A loss of signal from all receivers may result in an alert being sent to the monitor 116.

Live feeds of the movement in the tracking and alert system 100 may be recorded at the monitor 116 in a storage medium 118 so that, if the signal is lost, the last known location, including the path and timing to get to the last known location, may be recovered and retraced. Additionally, for example, prior similar paths and/or last known locations, and the immediate subsequent location or locations, may be used to suggest a next location.

In some embodiments, a tampering signal may be sent to the wearer to give the wearer an opportunity to cancel the alert in the case of a false alarm. The tampering signal may be a visual signal, such as a light emitting diode (LED), an audible signal, or a tactile signal such as vibrations or a shock, or any combination thereof. To further reduce the occurrences of false alarms, in other words, alerts sent when the wearer is not in danger or lost, may be cancelled within the tracking and alert system by a cancelling means 124. The cancelling means 124 either temporarily turns the tracker 102 off, or indicates to the monitor 116 that there is no danger. The cancelling means 124 may be a simple button, switch, dial, microphone, scanner, or any other input device. To prevent unwanted actuation of the cancelling means 124, the button may be hidden or protected with a cover, or locked physically or electronically. Alternatively, the cancelling means 124 may be a series of buttons that must be actuated in a specific sequence like a code, or a voice recognition device that recognizes the voice of the wearer, and/or entry of a password. Of course, those skilled in the art will appreciate, in light of the disclosure herein, that other cancelling means 124 may be used to prevent false alarms.

The tracking device 102 may further include a power button 126 to simply turn the device off when not in use, and/or to notify the monitor that the device has been voluntarily turned off. To assure that the turning-off of the device off was authorized, the power button 126 may also require a specific key, code, sequence of actions, identification recognition means, and/or the like to be deactivated. In some embodiments, incorrectly actuating the power button 126 may give the impression that the power is off when in fact, the power remains on, such as to allow for continued tracking in an abduction circumstance. In addition, incorrectly actuating the power button 126 may also function as an alert to the monitor 116.

To reduce the delay of signaling trouble or distress, the tracking module system 102 may further include an emergency signaling means 125. Like the canceling means 124, the emergency signaling means 125 may be a button, switch, scanner, voice recognition device, and/or the like. By actuating the emergency signaling means 125, the wearer may send a signal to the monitor 116 to indicate that the wearer is in some kind of trouble or distress. The monitor 116 may then identify the location of the tracking module 100 and alert the proper authorities.

In certain of the aforementioned exemplary embodiments, safety zones may be preprogrammed into the tracking module 102 and/or the monitor 116, such that when the wearer enters a hot zone or leaves the safety zone, an alert is sent to or sounded at the monitor 116. In addition, the alert may be sounded at the tracking device 102 to notify the wearer and those around the wearer that the wearer is in a hot zone or has left the safety zone. Such preprogrammed information to sound an alarm locally may be stored locally in a storage device 111 on the tracking module 102, or may be sent to the device 102 in real time, for example.

The local storage device 111 may also store information regarding the wearer, such as a profile, identification, physical characteristics, contact information, special needs, medical issues or history, and the like. This information may also be transmitted to the monitor 116 and may be particularly useful in situations wherein the monitor 116 is managed or accessed by third parties, such as the police or security service providers, who may not know the wearer.

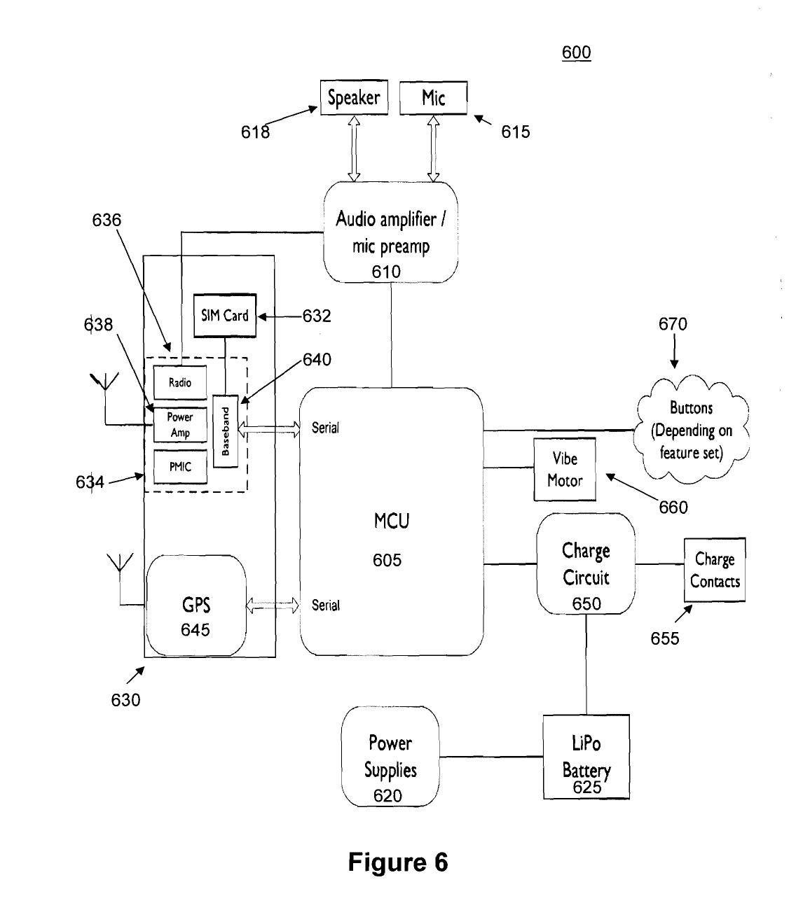

FIG. 6 illustrates a block diagram of a circuit 600. Circuit 600 may include a microcontroller 605, an audio amplifier and/or microphone preamplifier 610 associated with a microphone 615 and speaker 618, at least one power supply 620 and battery 625 interconnected to charge circuit 650 and associated charge contacts 655, a cell phone technology core 630, such as including a SIM card 632, PMIC 634, radio 636, power amplifier 638, baseband 640 and GPS 645, a vibe motor 660, and button(s) 670. Microcontroller 605 may be interoperably connected to amplifier/preamplifier 610, charge circuit 650, vibe motor 660, and buttons 670. Microcontroller 605 may also be communicatively connected to cell phone technology 630.

Microcontroller 605 may take the form of a small computer on a single integrated circuit, consisting internally of a computer processing unity, clock, timers, input/output ports, and memory. Program memory, such as in the form of NOR flash or OTP ROM, may be operably included within microcontroller 605. Microcontroller 605 may optionally include random access memory (RAM). Microcontroller 605 may be designed or dedicated specifically for use in the present invention, or may be a more generic form of a microcontroller designed for general functionality. By way of example, microcontroller 605 may be designed to operate using four-bit words and operate at clock rate frequencies as low as 4 kHz, to thereby enabling low power consumption. Microcontroller may retain functionality as described herein while monitoring for interaction, such as a button 670 being pressed, or interaction with microphone 615 or speaker 618, for example. Microcontroller 605 may be further designed to reduce power consumption while awaiting interaction, such as by shutting off the CPU clock and/or turning off other functionality to enable long battery life.

Amplifier/preamplifier 610 may be electrically interconnected with microcontroller 605, to thereby receive control signals from and provide signals to microcontroller 605. Amplifier/preamplifier may additionally be electrically interconnected to cell phone technology 630, such as to allow receipt and transmission of signals to be passed fro microphone 615 and speaker 618. Amplifier/preamplifier 610 may include an audio amplifier electrically interconnected with a microphone 615 and speaker 618. Amplifier/preamplifier 610 may be an electronic amplifier that amplifies low-power audio signals, such as signals composed primarily of frequencies between 20 hertz to 20,000 hertz that represents approximately the human range of hearing, to a level suitable for driving speaker 618. Amplifier/preamplifier 610 may include a low power audio amplifier(s) to perform pre-amplification, equalization, tone control, and/or mixing/effects. Input signals into amplifier/preamplifier 610 may be on the order of a few hundred microwatts, and may be output at approximately ten to hundreds, or thousands, of watts, for example.

Amplifier/preamplifier 610 may include a microphone preamplifier that may be used to increase microphone 615 output voltage to a more usable level. Amplifier/preamplifier 610 may provide a stable gain for small input signals, while maintaining insulation from induced noise from cabling and avoiding distortion of large amplitude signals.

Microphone 615 may be operably connected to amplifier/preamplifier 610 to allow for input of audio into circuit 600, such as audio from a user of circuit 600, for example. Microphone 615 may take the form of an acoustic-to-electric transducer or like sensor that converts sound into an electrical signal for passing to amplifier/preamplifier 610. Microphone 615 may use electromagnetic induction, such as a dynamic microphone, capacitance change, such as a condenser microphone, piezoelectric generation, and/or light modulation to produce the electrical signal from mechanical vibration of the acoustic signal.

Speaker 618 may be operably connected to amplifier/preamplifier 610 to allow for output of audio signals from circuit 600, such as to a user of circuit 600, for example. Speaker 618 may be an electro-acoustic transducer to convert an electrical signal into sound. Speaker 618 may vibrate correspondent to the variations of an input electrical signal from amplifier/preamplifier 610 to thereby cause sound waves to propagate therefrom.

Charge circuit 650 may be electrically interconnected to microcontroller 605 to thereby provide power to microcontroller 605. Charge circuit 650 may also be controlled by microcontroller 605. Charge circuit may control the input of electrical power from charge contacts 655 to battery 625, for example. Charge contacts 655 may take the form of any electrical connection external to a device to thereby provide input electrical energy. This input electrical energy may by controlled by charge circuit 650 to charge battery 625. Battery 625 may take the form of a lithium-ion polymer battery, polymer lithium ion, and/or lithium polymer batteries (Li-poly, Li-Pol, LiPo, LIP, PLI and/or LiP), or any form of rechargeable battery, such as a secondary cell battery. Battery 625 may further include multiple parallel or series batteries, although for ease of discussion herein battery is referred to in the singular. Battery 625 may be composed of several identical secondary cells in parallel, such as to increase the discharge current capability.

Circuit 600 may also include a power supply 620 interconnected to battery 625. Power supply 620 may be a source of electrical power, such as a device or system that supplies electrical or other types of energy to an output load or group of loads. Power supply 620 may take the form of an electrical energy supply, a mechanical energy supply and/or other energy source, for example.

Circuit 600 may also include cell phone technology 630 communicatively coupled to microcontroller 605. Cell phone technology 630 may also be interconnected to amplifier/preamplifier 610. Cell phone technology 630 may include a SIM card 632, a PMIC 634, radio 636, power amplifier 638, baseband 640 and/or GPS 645, by way of non-limiting example. Cell phone technology 630 may be used for mobile telecommunications, such as mobile telephone, text messaging or data transmission, for example, over a cellular network. Cell phone technology 630 may provide full duplex communication, including automated calling to and paging from a public land mobile network (PLMN), and handoff during a communication when the user moves from one cell, such as a base station coverage area, to another. Cell phone technology may include standard voice function, SMS for text messaging, email, packet switching for access to the Internet, gaming, Bluetooth, infrared, camera with video recorder and/or MMS for sending and receiving photos and video, MP3 player, radio and/or GPS, for example.

Cell phone technology 630 may include a SIM card 632. As is known to those possessing an ordinary skill in the pertinent arts, mobile phones require a small microchip, called a Subscriber Identity Module (SIM) Card, to function. SIM card 632 may be approximately the size of a small postage stamp, and may store cell phone technology's 630 configuration data and information about cell phone technology 630, such as the communication plan used, for example. SIM Card 632 may be activated by use of a unique numerical identifier. Alternatively or additionally, SIM card 632 may take the form of a memory with data programmed therein. This data may be accessed by using a special digit sequence to access the “NAM,” as in “Name” or number programming menu.

Cell phone technology 630 may also include a power management integrated circuit (PMIC) 634 integrated within cell phone technology 630 to provide power management. PMIC 634 may include battery management, voltage regulation, and charging functions, for example. Further, PMIC 634 may include DC to DC converter and may provide dynamic voltage scaling. PMIC may use Pulse Frequency Modulation (PFM), pulse-width modulation (PWM) and/or a switching amplifier, for example.

Radio 636 may be included within cell phone technology 630 to provide wireless connectivity to a communication network, such as a telephone network, for example. Radio 636 may provide signals for connection using analog cellular telephony, such as 1G, digital mobile communication, such as 2G, wideband mobile communication, such as 3G, and/or broadband fourth generation, such as 4G.

Cell phone technology 630 may also include a baseband 640. Baseband may provide signal processing, including signals with a band of frequencies starting at zero Hz. Baseband 640 may be a lowpass band filtering, as compared to radio 636 signal.

Global Positioning System (GPS) 645, as described hereinabove, may include technology to interact with a space-based global navigation satellite system. GPS 645 may provide reliable positioning, navigation, and timing services to worldwide users on a continuous basis in all weather, day and night, and from anywhere on or near the Earth having an unobstructed view of four or more GPS satellites. GPS satellites broadcast signals from space that GPS receivers, such as GPS 645, use to provide three-dimensional location (latitude, longitude, and altitude) and precise time. GPS 645 may provide navigation worldwide.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by the detailed description, but rather by the claims appended hereto and the equivalents thereof.

1. A personal tracking system, comprising:
a wearable device, comprising at least:
a geographic locator;
at least one fastener, comprising at least one detector that detects an unfastening of said at least one fastener;
at least one audio and one visual indicator that indicates a remote communication;
at least one remote monitoring device that remotely monitors the geographic locator, that remotely monitors the at least one detector, that provides at least a portion of the remote communication, and that provides outputs correspondent thereto; and
a map display that displays, to at least one user, the outputs of said at least one monitoring device.

2. The personal tracking system of claim 1, wherein the geographic locator comprises at least a GPS locator.

3. The personal tracking system of claim 2, wherein the geographic locator comprises a GPS locator, a GSM locator, a GPRS locator, and a WLAN locator.

4. The personal tracking system of claim 3, wherein the geographic locator further comprises a locator switch that switches to the one of GPS, GSM, GPRS and WLAN having a highest signal strength.

5. The personal tracking system of claim 2, wherein the geographic locator further comprises a triangulation module.

6. The personal tracking system of claim 1, wherein the map display further comprises an audio display.

7. The personal tracking system of claim 1, wherein said wearable device comprises a wristband.

8. The personal tracking system of claim 7, wherein the wristband further comprises a decorative cover.

9. The personal tracking system of claim 8, wherein the decorative cover comprises a clip-on to said wearable device.

10. The personal tracking system of claim 1, wherein said at least one audio indicator comprises at least a microphone and a speaker.

11. The personal tracking system of claim 1, wherein said at least one visual indicator comprises at least two lights.

12. The personal tracking system of claim 11, wherein the lights comprise LEDs.

13. The personal tracking system of claim 1, wherein said at least one visual indicator comprises a viewing screen.

14. The personal tracking system of claim 1, wherein the remote communication comprises a recorded one of the audio indications.

15. A method of remotely monitoring at least a geographic location of a person, comprising:
providing at least one wearable device comprising at least two of a GPS, GSM, GPRS, WLAN and triangulation locators;
remotely monitoring the locators;
remotely monitoring for an alert that the wearable device is removed;
providing for remote communication between the remote monitor of the locators and the wearable device; and
remotely displaying an outcome of at least said remotely monitoring the locators, said remotely monitoring for the alert, and said providing for remote communications.

16. A remote monitor for monitoring at least a geographic location of an item, comprising:
at least one attachable device comprising at least two of a GPS, GSM, GPRS, WLAN and triangulation locators;
means for remotely monitoring the locators;
means for remotely monitoring for an alert that the attachable device is removed;
means for providing for remote communication between the means for remotely monitoring and the attachable device; and
a display for displaying output of at least said means for remotely monitoring the locators, said means for remotely monitoring for the alert, and said means for providing for remote communications.

17. The remote monitor of claim 16, wherein said at least one attachable device comprises an audio indicator that comprises at least a microphone and a speaker.

18. The remote monitor of claim 16, wherein said at least one attachable device comprises at least one visual indicator that comprises at least two lights.

19. The remote monitor of claim 18, wherein the lights comprise LEDs.

20. The remote monitor of claim 16, wherein the item comprises an object.
